(19) United States
(12) Patent Application Publication
(10) Pub. No.: US 2010/0037225 A1
(43) Pub. Date: Feb. 11, 2010

(54) WORKLOAD ROUTING BASED ON GREENNESS CONDITIONS

(75) Inventors: Ronald P. Doyle, Raleigh, NC (US); David L. Kaminsky, Chapel Hill, NC (US); Edith H. Stern, Yorktown Heights, NY (US); Barry E. Willner, Briarcliff Manor, NY (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/187,518

(22) Filed: Aug. 7, 2008

(51) Int. Cl. G06F 9/50

(52) U.S. Cl. 718/102

(57) ABSTRACT

Workload requests are routed in response to server greenness conditions. A workload request is received for a remotely invocable computing service executing separately in different remotely and geographically dispersed host computing servers. Greenness conditions pertaining to production or conservation of energy based upon external factors for each of the different remotely and geographically dispersed host computing servers are determined. The workload request is routed to one of the different remotely and geographically dispersed host computing servers based upon the determined greenness conditions.

### BACKGROUND OF THE INVENTION

The present invention relates to the field of request processing and workload routing in a server farm and more particularly to load balancing server requests in a server farm.

Today, server farms host many computing sites, where a group of servers can be clustered together to act as a unified server to external clients. Any given request could be handled by any of several servers, thereby improving scalability and fault-tolerance. The switching infrastructure connecting the servers to the hosting network generally includes one or more redirecting server switches to route incoming request traced to the servers. Referred to in the art as request distributors, these switches select individual servers to handle each incoming request. Thus, the server selection policy can play an important role in managing cluster resources in order to maximize throughput and meet quality-of-service goals.

Conventional server switches often incorporate a variety of request routing methodologies when distributing requests to backend server processes. In particular, the server selection methodologies can be selected in order to maximize throughput and minimize response latency. For instance, server load balancing oriented methodologies monitor server status and direct requests to lightly loaded servers. Notably, server load balancing switches often are referred to as Layer 4 switches because server load balancing switches make server selection decisions at connection setup time, and examine only the Layer 4 transport headers of the incoming packet stream.

Content-aware server selection policies, by comparison, prefer servers that can handle a given request most efficiently. Importantly, the most efficient requesting handling servers incorporate caching technology and, accordingly, the server most likely to be able to process a request most effectively is the server likely to have the requested data in cache. Uniform Resource Locator (URL) hashing is a content-based policy that applies a simple deterministic hash function upon the request URL to select a server. URL hashing has often been referred to as a Layer 7 policy because the URL hashing switch typically parses protocol headers at Layer 7 in order to extract the respective URL.

Presently, both Layer 4 and Layer 7 switching strategies select individual servers to process requests based upon either the ability of the selected servers to respond to a request in a timely manner, or based upon the importance of the content to be processed in the selected servers, or even based upon the identity of the requester.

### BRIEF SUMMARY OF THE INVENTION

In an embodiment of the invention, a method for routing workload requests according to server greenness conditions can be provided. The method can include receiving a workload request for a remotely invocable computing service executing separately in different remotely and geographically dispersed host computing servers, determining greenness conditions pertaining to production or conservation of energy based upon external factors for each of the different remotely and geographically dispersed host computing servers, and routing the workload request to one of the different remotely and geographically dispersed host computing servers based upon the determined greenness conditions.

In another embodiment of the invention, a workload routing data processing system can be configured for routing workload requests according to server greenness conditions. The system can include a computing platform configured for communicative coupling to remotely and geographically dispersed host computing servers over a computer communications network in which each of the host computing servers hosts an instance of a remotely invocable service. The system also can include a greenness monitor configured to monitor greenness conditions in each of the host computing servers. In this regard, the greenness conditions pertain to the production or conservation of energy based upon external factors for each of the host computing servers. Finally, the system can include a greenness service switch coupled to the greenness monitor and executing as program code in the computing platform. The switch can include program code enabled to route workload requests for the remotely invocable service to selected ones of the host computing servers based upon the monitored greenness conditions.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for routing workload requests according to server greenness conditions;

FIG. 2 is a schematic illustration of a data processing system configured for routing workload requests according to server greenness conditions; and,

FIG. 3 is a flowchart illustrating a process for routing workload requests according to server greenness conditions.

### DETAILED DESCRIPTION OF THE INVENTION

As will be appreciated by one skilled in the art, the present invention may be embodied as a method, data processing system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Embodiments of the present invention provide a method, system and computer program product for routing workload requests according to greenness conditions. In accordance with an embodiment of the present invention, greenness conditions can be monitored for different servers in different data centers in a geographically diverse cluster, each of the servers supporting the operation of a particular service. In this regard, a geographically diverse cluster can include different data centers disposed a distance apart from one another ranging from a different building to a different municipality. Further, a particular service can include program code performing data processing in respect to an input set to produce an output set such that the service provides the same application programming interface (API) irrespective of the actual program code included in the particular service to perform the data processing.

The greenness conditions can include known excess energy production within a corresponding geographic locale. Alternatively, the greenness conditions can include known excess consumption of energy within a corresponding geographic locale such that an increased computing load in a server within the geographic locale can contribute a brownout condition. The greenness conditions further can include known weather conditions within a corresponding geographic locale and also the type of resources used to generate power in the corresponding geographic locale. As workload requests for the service are received in a server switch, the workload requests can be routed to an available one of the servers hosting the service according to optimal greenness conditions.

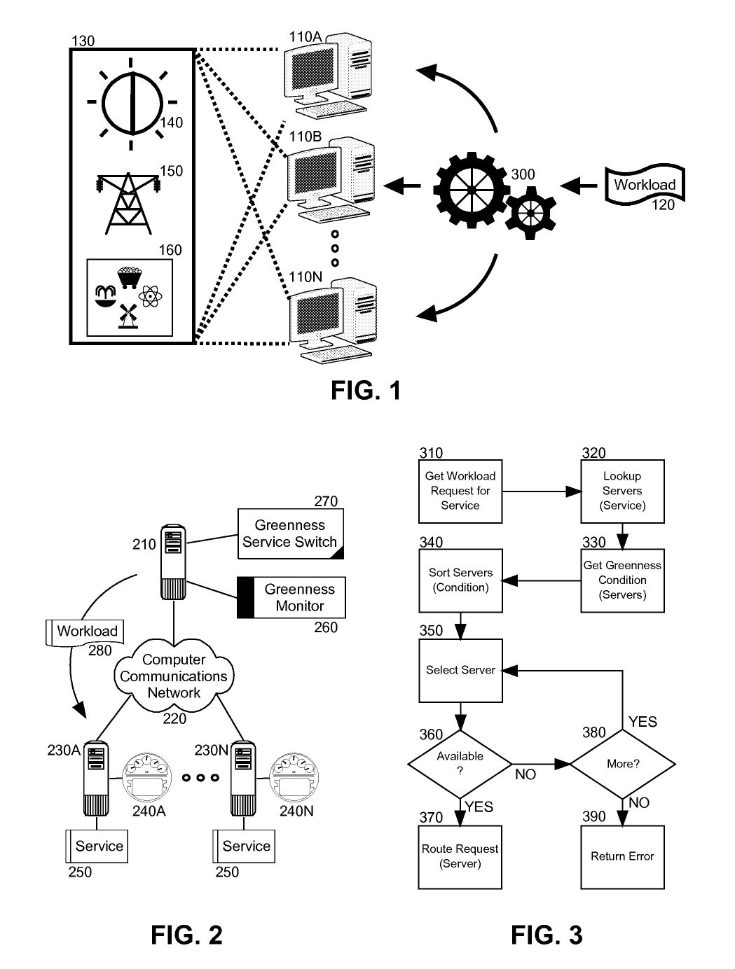

In further illustration, FIG. 1 pictorially shows a process for routing workload requests according to server greenness conditions. As shown in FIG. 1, different host servers 110A, 110B, 110N dispersed within different data centers about different geographic locations each can demonstrate greenness conditions 130—namely conditions pertaining to the production or conservation of energy based upon external factors such sensed weather 140, excess power generation capacity 150 and resource type 160 consumed to generate power. In particular, power generation capacity 150 refers to the available power in a power grid supporting a particular one of the host servers 110A, 110B, 110N, and the consumed resource type 160 refers to the type of resources consumed to generate the power in the power grid, including coal, nuclear fuel, wind and hydroelectric. Finally, the sensed weather 140 can include an indication of weather conditions for a particular one of the host servers 110A, 110B, 110N used to infer available power for the particular one of the host servers 110A, 110B, 110N. Specifically, cooler weather conditions can infer lower power consumption in a geographic region affected by those weather conditions, while hotter weather conditions can infer higher power consumption.

A workload routing process 300 can monitor the greenness conditions 130 for each of the host servers 110A, 110B, 110N and the workload routing process 300 can rate each of the host servers 110A, 110B, 110N according to the monitored greenness conditions 130. Consequently, when a workload 120 requiring access to a service executing on the host servers 110A, 110B, 110N is received in the process for workload routing based upon greenness conditions 300, the workload routing process 300 can select a particular one of the host servers 110A, 110B, 110N based upon an optimal rating of greenness conditions 130 for the particular one of the host servers 110A, 110B, 110N. For instance, a particular one of the host servers 110A, 110B, 110N demonstrating a highest degree of excess power generation capacity 150 can be selected so as to not waste excess power generation capacity. Also, a particular one of the host servers 110A, 110B, 110N demonstrating the coolest sensed weather 140 can be selected so as to optimally utilize excess power generation capacity. Or the particular one of the host servers 110A, 110B, 110N demonstrating the most environmentally friendly resource type 160 used in generating power can be selected.

The process described in FIG. 1 can be implemented within a data processing system arranged as shown schematically in FIG. 2. Referring to FIG. 2, a computing platform 210 can be communicatively coupled to one or more host servers 230A . . . 230N over computer communications network 220. Each of the host servers 230A . . . 230N can be located in a different geographic region and each can support the operation of an instance of a computing service 250, such as remotely invocable program code like a Web service. Each of the host servers 230A . . . 230N further can be associated with individual greenness conditions 240A . . . 240N. In this regard, the greenness conditions 240A . . . 240N can include conditions pertaining to the production or conservation of energy based upon external factors such sensed weather 140, excess power generation capacity 150 and resource type 160 consumed to generate power.

The computing platform 210 can be coupled to a greenness service switch 270 and the computing platform 210 also can be coupled to a greenness monitor 260. The greenness monitor 260 can be configured to monitor the greenness conditions 240A . . . 240N in each of the host computing servers 230A . . . 230N and to apply a rating to each of the host computing servers 230A . . . 230N based upon the monitored greenness conditions. For example, the rating can be a composite score of each of the monitored greenness conditions 240A . . . 240N, or the rating can be a value computationally produced based upon each of the monitored greenness conditions 240A . . . 240N.

The greenness service switch 270, in turn, can include program code enabled to route inbound workloads 280 requiring processing by the service 250 to selected ones of the host computing servers 230A . . . 230N based upon the rating applied to each of the host computing servers 230A . . . 230N by the greenness monitor 260. The selection of a particular one of the host computing servers 230A . . . 230N can be based upon a highest rating amongst available ones of the host computing servers 230A . . . 230N, or a highest rating for any given one of the greenness conditions 240A . . . 240N for available ones of the host computing servers 230A . . . 230N. In this way, host computing servers 230A . . . 230N demonstrating the most energy efficient, environmentally friendly operating conditions can be favored in routing the workloads 280 over host computing servers 230A . . . 230N demonstrating less energy efficient, less environmentally friendly operating conditions.

In yet further illustration of the operation of the greenness service switch 270 and the greenness monitor 260, FIG. 3 is a flowchart illustrating a process for routing workload requests according to server greenness conditions. Beginning in block 310, a workload request can be received for a particular service executing remotely in a host computing server, for example a Web service. In block 320, a selection of different host computing servers supporting the requested service can be located and in block 330 the greenness conditions for each of the host computing servers in the selection can be retrieved. For instance, the greenness conditions can be reduced to a single rating or set of ratings.

Thereafter, in block 340 the host computing servers in the selection can be sorted in descending order, for example, and in block 350 a first of the host computing servers in the list can be selected. In decision block 360, it can be determined if the selected one of the host computing servers is available to process the workload request. If not, in decision block 380 it can be determined whether additional host computing servers remain to be processed in the list. If not, in block 390 an error can be returned. Otherwise, a next host computing server in the list can be selected in block 350 and again in decision block 360 it can be determined whether or not the selected host computing server is available to process the workload request. If so, the workload request can be routed to the selected host computing server in block 370. Otherwise, the process can repeat through decision block 380.

Having thus described the invention of the present application in detail and by reference to embodiments thereof, it will be apparent that modifications and variations are possible without departing from the scope of the invention defined in the appended claims.

We claim:

1. A method for routing workload requests according to server greenness conditions, the method comprising:
receiving a workload request for a remotely invocable computing service executing separately in different remotely and geographically dispersed host computing servers;
determining greenness conditions pertaining to production or conservation of energy consumed by each of the host computing servers based upon external factors for each of the different remotely and geographically dispersed host computing servers; and,
routing the workload request to one of the different remotely and geographically dispersed host computing servers based upon the determined greenness conditions.

2. The method of claim 1, wherein receiving a workload request for a remotely invocable computing service executing separately in different remotely and geographically dispersed host computing servers, comprises receiving a workload request for a remotely invocable Web service executing separately in different remotely and geographically dispersed host computing servers.

3. The method of claim 1, wherein determining greenness conditions pertaining to production or conservation of energy consumed by each of the host computing servers based upon external factors for each of the different remotely and geographically dispersed host computing servers, comprises determining greenness conditions pertaining to production or conservation of energy consumed by each of the host computing servers responsive to an indication of weather conditions for each of the different remotely and geographically dispersed host computing servers.

4. The method of claim 1, wherein determining greenness conditions pertaining to production or conservation of energy consumed by each of the host computing servers based upon external factors for each of the different remotely and geographically dispersed host computing servers, comprises determining greenness conditions pertaining to production or conservation of energy consumed by each of the host computing servers based upon excess power generation capacity for each of the different remotely and geographically dispersed host computing servers.

5. The method of claim 1, wherein determining greenness conditions pertaining to production or conservation of energy consumed by each of the host computing servers based upon external factors for each of the different remotely and geographically dispersed host computing servers, comprises determining greenness conditions pertaining to production or conservation of energy consumed by each of the host computing servers based upon resource type consumed to generate power for each of the different remotely and geographically dispersed host computing servers.

6. The method of claim 1, wherein routing the workload request to one of the different remotely and geographically dispersed host computing servers based upon the determined greenness conditions, comprises routing the workload request to one of the different remotely and geographically dispersed host computing servers based upon a rating computed for the determined greenness conditions.

7. A workload routing data processing system configured for routing workload requests according to server greenness conditions, the system comprising:
a computing platform configured for communicative coupling to a plurality of remotely and geographically dispersed host computing servers over a computer communications network, each of the host computing servers hosting an instance of a remotely invocable service;
a greenness monitor configured to monitor greenness conditions in each of the host computing servers, the greenness conditions pertaining to production or conservation of energy consumed by each of the host computing servers based upon external factors for each of the host computing servers; and,
a greenness service switch coupled to the greenness monitor and executing as program code in the computing platform, the switch comprising program code enabled to route workload requests for the remotely invocable service to selected ones of the host computing servers based upon the monitored greenness conditions.

8. The system of claim 7, wherein the greenness conditions comprise an indication of weather conditions for each of the host computing servers.

9. The system of claim 7, wherein the greenness conditions comprise excess power generation capacity.

10. The system of claim 7, wherein the greenness conditions comprise excess consumption of energy within a corresponding geographic locale such that an increased computing load in a server within the corresponding geographic locale can contribute to a brownout condition in the corresponding geographic locale.

11. The system of claim 7, wherein the greenness conditions comprise resource type consumed to generate power.

12. A computer program product for routing workload requests according to server greenness conditions, the computer program product comprising:
a computer usable medium having computer usable program code embodied therewith, the computer usable program code comprising:
computer usable program code for receiving a workload request for a remotely invocable computing service executing separately in different remotely and geographically dispersed host computing servers;
computer usable program code for determining greenness conditions pertaining to production or conservation of energy consumed by each of the host computing servers based upon external factors for each of the different remotely and geographically dispersed host computing servers; and,
computer usable program code for routing the workload request to one of the different remotely and geographically dispersed host computing servers based upon the determined greenness conditions.

13. The computer program product of claim 12, wherein the computer usable program code for receiving a workload request for a remotely invocable computing service executing separately in different remotely and geographically dispersed host computing servers, comprises computer usable program code for receiving a workload request for a remotely invocable Web service executing separately in different remotely and geographically dispersed host computing servers.

14. The computer program product of claim 12, wherein the computer usable program code for determining greenness conditions pertaining to production or conservation of energy consumed by each of the host computing servers based upon external factors for each of the different remotely and geographically dispersed host computing servers, comprises computer usable program code for determining greenness conditions pertaining to production or conservation of energy consumed by each of the host computing servers responsive to an indication of weather conditions for each of the different remotely and geographically dispersed host computing servers.

15. The computer program product of claim 12, wherein the computer usable program code for determining greenness conditions pertaining to production or conservation of energy consumed by each of the host computing servers based upon external factors for each of the different remotely and geographically dispersed host computing servers, comprises computer usable program code for determining greenness conditions pertaining to production or conservation of energy consumed by each of the host computing servers based upon excess power generation capacity for each of the different remotely and geographically dispersed host computing servers.

16. The computer program product of claim 12, wherein the computer usable program code for determining greenness conditions pertaining to production or conservation of energy consumed by each of the host computing servers based upon external factors for each of the different remotely and geographically dispersed host computing servers, comprises computer usable program code for determining greenness conditions pertaining to production or conservation of energy consumed by each of the host computing servers based upon resource type consumed to generate power for each of the different remotely and geographically dispersed host computing servers.

17. The computer program product of claim 12, wherein the computer usable program code for routing the workload request to one of the different remotely and geographically dispersed host computing servers based upon the determined greenness conditions, comprises computer usable program code for routing the workload request to one of the different remotely and geographically dispersed host computing servers based upon a rating computed for the determined greenness conditions.
